(19) United States
(12) Patent Application Publication
(10) Pub. No.: US 2006/0031476 A1
(43) Pub. Date: Feb. 9, 2006

(54) Apparatus and method for remotely monitoring a computer network

(76) Inventors: Marvin Lee Mathes, Hampton, VA (US); Nick Lee Mathes, Hampton, VA (US)

Correspondence Address: BANNER DEVELOPMENT, INC., 19 CHENANGO STREET, SUITE 904, BINGHAMTON, NY, 13901, US

(21) Appl. No.: 10/912,360

(22) Filed: Aug. 5, 2004

(51) Int. Cl. G06F 15/173

(52) U.S. Cl. 709/224

(57) ABSTRACT

There is provided an apparatus for remotely monitoring a computer network. Monitoring is performed using an inside out approach from behind firewalls and other security devices. The monitoring appliance is shipped to a client site preconfigured and typically requires no technically trained person for installation. Collected network data is periodically transmitted to a remote monitoring facility where it is recorded and analyzed. Both the monitoring appliance and the remote center maintain the configuration data. Typically, no client data is transmitted to the remote monitoring site. If the monitoring appliance fails, a completely configured replacement may be shipped to the site and easily installed. The monitoring appliance is optionally equipped to provide network services. Services such as web hosting, file server, print server, virtual private network (VPN), shared Internet access, web content filtering, anti-virus, spam e-mail elimination, and IP telephony services as well as other such services may be easily provided.

### FIELD OF THE INVENTION

The present invention relates to monitoring a computer network and, more specifically, to an apparatus method for inside out, remote analysis of a computer network and of individual components connected to the computer network.

### BACKGROUND OF THE INVENTION

Computer networks, once the exclusive domain of Fortune 500 companies, have now infiltrated virtually every business and many homes in the United States and other countries. The complexity of both individual computers attached to a network as well as the networking hardware and software have concurrently increased. The computer network has now become mission critical to ever-smaller businesses and organizations. As these mission critical networks have been deployed in smaller and smaller organizations, the ability to provide an on-site, experienced, typically highly paid Information Technology (IT) support person has become more and more difficult. To add yet another complicating factor, security concerns have forced deeper and deeper isolation of these networks, removing most possibilities for outside access for monitoring, configuration, and/or remediation of problems. Any hole or portal through which an experienced technician might remotely access a network also provides an easy target for a hacker or other mischievous person. Additionally, if a network is experiencing a problem, enough functionality may be impaired to render outside access and remediation impossible.

In the past, one solution has been to hire an outside consultant who must, when his or her schedule permits, travel to the network site and perform reconfigurations, repairs, or upgrades. If a mission critical network is down, this solution, while financially attractive relative to supporting a full-time, on-site support person, may still be unacceptable.

Some organizations offer remote monitoring of networks. Such remote monitoring services require that the customer or other user provide an expensive network connection to the remote network being monitored. Alternatively, the remote monitoring services may require that “holes” be opened in the monitored network's firewall, allowing the monitoring service access to the network via the Internet. Consequently, the more access to network resources provided to the monitoring service, the greater the risk of a network security breach. Remote monitoring services, if provided sufficient levels of access could, for example, “ping” network devices to ascertain their operational status, check for running network services (e.g., web server and e-mail), or even read management information bases (MIB) tables built into some devices such as routers using Simple Network Management Protocol (SNMP). While SNMP is generally limited to reporting operational statistics, such monitoring usually requires providing outside access to critical devices such as web servers, routers, and file servers. Fully securing such devices would, therefore, remove any ability to monitor them. These prior art monitoring solutions typically offer little more than a “your network/network device or service is down” level of information. They offer no detailed, predictive monitoring which may be useful in performing a preemptive maintenance action to ensure maximum network uptime. Also, prior art monitoring systems are incapable of performing any corrective or remedial action when a network problem occurs.

Providing a variety of network services across a network is also typically expensive. Both server hardware and network server software are generally expensive, both in initial acquisition costs and in installation and configuration costs. In addition, frequent updates/upgrades are typically required. Installation, configuration, and other such upgrades generally require the services of an expert and can typically take many hours or even days to complete.

In contradistinction, the monitoring system of the present invention provides an inside out monitoring solution, which is not limited by firewalls or other security devices or techniques. The novel inventive monitoring apparatus and method leaves no back doors or other portals that could be exploited by hackers. Also, many network operating parameters are continuously measured, and extremely detailed information is reported to a remote site where either an automated response (i.e., an automated solution) may be generated or, in extreme cases, an expert support technician may be utilized to analyze the problem and respond appropriately. In most cases such response are only from the within the appliance itself and the remote monitoring site. While it is conceivable that a problem might only be solvable by a visit to the monitored site by a technician, this contingency is considered extremely unlikely.

Because the monitoring apparatus and method of the invention has been created by computer network engineers with many years of experience with both large and small networks, the inventive system embodies the inventors' cumulative knowledge and experience in solving a myriad of problems over many years. This is made possible by resources provided within the inventive appliance and/or remote monitoring center that, in many cases, “solve” the network problem(s) automatically (i.e., without human intervention).

In addition, the apparatus and method of the present invention may inexpensively provide network services to network users on a subscription basis. This not only eliminates large capital expenses but also allows network services to be provided out-of-the-box without requiring any on-site configuration. Updates to existing services may be provided without the necessity of an on-site visit by a technician.

### DISCUSSION OF THE RELATED ART

U.S. Pat. No. 6,684,241 for APPARATUS AND METHOD OF CONFIGURING A NETWORK, issued Jan. 27, 2004 to Haldon J. Sandlick et al. teaches a system designed to capture and parse broadcast network packets transmitted by other network devices to facilitate self-configuration. A newly attached router or other such device gathers the broadcast settings of other routers or devices that are already connected to the network, allowing the newly attached router (or other applicable devices) to apply the broadcast settings of other devices to itself. The newly attached router or device either guesses or assumes settings, which could then be displayed to via a graphic user interface (GUI) for a network administrator to accept or correct.

The SANDLICK et al. apparatus differs from the apparatus of the present invention in both purpose and functionality and, consequently, in structure. The inventive system is not intended as an auto-configuration protocol, and does not analyze broadcast traffic for the purpose of guessing the most likely settings for its own configuration, which must then be reviewed for accuracy by a human technician. Rather, the inventive system maintains a more comprehensive assortment of network and user account data. Any changes in network configuration are automatically updated in a database both locally and centrally to ensure rapid restoration of service in even the most catastrophic failures, including total destruction of the on-site device. The inventive system captures and analyzes network traffic for a variety of purposes, but not for self-configuration as is taught by SANDLICK et al.

In addition, the SANDLICK et al. system appears to have a significant flaw. The SANDLICK et al. system does not appear to designate a known accurate master controller from which to receive its configuration information. Consequently, it is possible for devices to improperly configure themselves by gathering random configuration data from other improperly configured network devices on the same broadcast domain.

It is also not uncommon to transport two or more logically separated networks on the same media. For example, a network used to connect the accounting department to the shipping docks might share the same physical media as the manufacturing department physically located in the middle of the two other departments. The network traffic in the departments is generally logically isolated from other network traffic by using different IP address ranges and masks for the two logically different networks. The SANDLICK et al. automatic configuration apparatus would probably have great difficulty determining which department on the media it must use to configure itself. Even a properly configured device might fail, come back online, and reconfigure itself automatically with settings from other improperly (relative to the network it was supposed to select) configured network devices broadcasting erroneous data. If, as SANDLICK et al. contend, no automatic configuration would be used without administrator intervention, then automatic configuration will not truly be achieved. The apparatus of the present invention is not prone to making such configuration errors.

U.S. Pat. No. 6,697,969 for METHOD, SYSTEM, AND PROGRAM FOR DIAGNOSING A COMPUTER IN A NETWORK SYSTEM issued Feb. 24, 2004 to Greg Elliot Merriam teaches a system designed to diagnose a computer's performance by downloading an object such as a JAVA script from the server to that computer over the network. This is a classic “outside in” approach fraught with problems inherent in such systems, particularly security risks. In contradistinction, the apparatus and method of the present invention continuously checks the network for problems from the inside (i.e., an “inside out” approach) and can take corrective action internally or notify a remote data center that can remotely initiate remedial action.

The system of the present invention is not reliant on a user or help desk employee initiating a diagnostic post failure. Rather, the inventive apparatus continuously checks the monitored network or device for processes or hardware states which have strayed out of acceptable operating ranges. The apparatus of the invention may then immediately initiate corrective action locally—in many cases, prior to noticeable degradation in service. In addition, the inventive system is preemptive, initiating action before serious system degradation occurs. Unlike MERRIAM, the inventive system tests at the remote location (i.e., within the monitored network), “inside out.” Consequently, testing is not affected by security devices between the monitored systems and the data center or help desk.

Since many Internet Trojans use java scripts to perform harmful actions, the MERRIAM technique could realize that many secured systems would not be permitted to execute the necessary java scripts upon which the MERRIAM diagnostic system relies. The inventive apparatus monitors systems at a very granular level while the MERRIAM system's diagnostic capability seems to be limited to measuring the failing device's communication throughput and comparing performance to itself and other devices. This type of diagnostic technique is flawed. For example, a device with a bad patch cable could exhibit poor performance when tested using the MERRIAM system. In reality, there could be nothing wrong with the tested device. Or, in an even more bizarre possible scenario, if a failing cable were located between the exterior diagnosing computer and 100 tested computers, would not all 100 computers test the same regardless of truly varying degrees of performance? In other words, because of the MERRIAM test strategy, the failing cable could become a limiting factor of throughput measurement.

The inventive apparatus, on the other hand, tests both discrete hardware and running processes in addition to such conditions as losses of communications and can, in many cases, automatically affect repair. Also, the inventive apparatus checks for throughput, connectivity, CPU load, transmission errors, temperature, and many other meaningful measurements. As already stated, the inventive monitoring system tests from the inside out, and is not restricted by any security devices that may be securing a monitored network.

U.S. Pat. No. 6,711,615 for NETWORK SURVEILLANCE, issued Mar. 23, 2004 to Phillip Andrew Porras et al. teaches a system for identifying suspicious network activity. The PORRAS et al. system differs significantly from the system of the present invention in structure, method, and purpose.

The inventive apparatus is not primarily intended as an intrusion detection system. Rather, the inventive system implements intrusion detection to prevent unauthorized changes to the network and implements techniques which are vendor independent and not closely connected to any particular vendor's products or product version. The PORRAS et al. system is tied very closely to the Microsoft Domain server network model. The PORRAS et al. patented device monitors the “Microsoft Domain” to create and maintain a baseline of network activity for comparative purposes. In theory, anomalies in network activity may indicate an intrusion.

The inventive apparatus, on the other hand, scans and maintains a database of files necessary for normal network operation. That database contains a baseline of files names, file sizes, change dates, and time stamps. Should any unauthorized changes occur to files listed in the database, an intrusion alarm is initiated. The inventive system also reviews logs for failing access attempts and suspicious network activity. The inventive system is simpler and much less prone to false intrusion alarms.

U.S. Pat. No. 6,714,977 for METHOD AND SYSTEM FOR MONITORING COMPUTER NETWORKS AND EQUIPMENT, issued Mar. 30, 2004 to John J. Fowler et al. teaches a system primarily designed to monitor the physical environment that houses computer servers using temperature and other sensors including a video camera. The FOWLER et al. system monitors the existence of communications to the servers using a simple ping technique.

The inventive system, on the other hand, encompasses temperature, ping, bandwidth, service port testing, and over 40 other network, software, and hardware tests, and is unique in its more comprehensive design, which balances centralization and decentralization, thereby eliminating points of failure that might make the monitoring system blind or mute. The FOWLER et al. apparatus produces no warning during a communications outage or complete power failure that prevents sending e-mails or pages. The inventive method of monitoring both inside and out provides detailed information in the event of a poor power condition or complete power failure, poor network performance, network intrusion, or even a communications failure. A hardware failure within the FOWLER et al. monitoring device would likely go unnoticed because once the monitoring device fails, it no longer performs its notification functions and becomes completely blind and mute. With the inventive apparatus, technicians at the remote monitoring center are rapidly notified of poor performance, failed hardware, failed communications, and even failed monitoring hardware or software because of the unique monitoring design of the inventive hardware.

The monitoring method of the invention initiates transmissions of detailed granular information from the inside of the monitored network to a central monitoring center on the outside. Analyzing a large number of criteria allows for early prediction of potential problems, often before a failure occurs. The inventive monitoring system is not blocked by firewalls and other security devices designed to prevent outside intrusion. Devices and users within a network monitored using the inventive method are generally trusted. However, the FOWLER et al. device would require that any security device such as a firewall be reconfigured to permit access from the outside to view any of the web enabled reports. This poses a potential security problem. Also, a technician viewing reports generated by the FOWLER et al. system would have limited capability to effect corrections from the technician's remote location. Many of the repairs effected by the inventive system are automated, and are most often initiated from within the network-monitoring device, not the remote monitoring center. The FOWLER et al. system has no central monitoring capability. The balance of centralized-redundant reporting and alerting combined with decentralized remote data acquisition and ability to execute tasks within the network itself makes the inventive method of monitoring and maintenance superior and unique.

### SUMMARY OF THE INVENTION

The present invention provides an apparatus and method for monitoring both a computer network, and, optionally, individual devices attached to the computer network. The monitoring is performed using an inside out approach (i.e., the monitoring appliance resides behind all firewalls and all other security devices and with rare exceptions, all communication with a remote site is initiated and controlled by the monitoring appliance itself). The monitoring appliance is typically shipped to a client site preconfigured with all necessary network information such as machine names, user IDs, passwords, etc., and typically requires no technically trained person to install it. Network data is collected and periodically securely transmitted to a remote monitoring facility (e.g., a central data center) where the monitored data is recorded and analyzed.

The monitoring appliance of the invention maintains exquisitely detailed network configuration data. The configuration data is also mirrored (i.e., stored) at the remote monitoring site. Optionally, the monitoring appliance may be upgraded/updated through a secure dial-up connection and an internal modem or via an Internet connection. Typically, for data security reasons, no client data is transmitted to the remote monitoring site. In the event of a monitoring appliance failure, a completely configured replacement may be shipped by an overnight or other suitable delivery service and the replacement appliance may be plugged in and ready to go early the next morning. Only two connections, in addition to electrical power, are required to connect the monitoring appliance to the network. Consequently, no technical expertise is required to effect the replacement. An optional, additional connection may be made to a UPS so that AC line power condition and UPS battery condition, etc. may be monitored.

The monitoring appliance is equipped to optionally provide network services often associated with a traditional network server's hardware and software. Services such as web hosting, file server, print server, virtual private network (VPN), shared Internet access, web content filtering, anti-virus, spam e-mail elimination, IP telephony services, intrusion detection, routing, DHCP, e-mail, DNS server, Web proxy, and backup, as well as other such services, either now known or which will be available in the future, may be easily provided.

The monitoring appliance is envisioned as part of a subscription system wherein it is provided to a customer at no up-front capital outlay or expense except for a periodic (e.g., monthly, quarterly, annual, etc.) monitoring and support fee. Consequently, a customer is free of the need to constantly upgrade hardware and/or software and to provide network support capability. The inventive monitoring appliance could, however, be supplied to end users under other business arrangements, for example, a one-time payment.

It is, therefore an object of the invention to provide a monitoring appliance that provides monitoring of parameters including network configuration parameters.

It is an additional object of the invention to provide a monitoring appliance that may be preconfigured and shipped to a client site for installation by non-technical personnel.

It is a further object of the invention to provide a monitoring appliance that provides predictive monitoring of itself, the network to which it is connected, other devices connected to the network, and network services.

It is another object of the invention to provide a monitoring appliance that communicates monitored information to a remote site.

It is a still further object of the invention to provide a monitoring appliance that continues to reliably monitor and service the computer network to which it is connected even in the event of a failure at a central data center or a failure of a communications network connecting the monitoring appliance to the central data center.

It is an additional object of the invention to provide a monitoring appliance that communicates with a remote data center using a wide area network (WAN) such as the Internet.

It is another object of the invention to provide a system wherein a large number of remotely located, dispersed, independent computer networks may be centrally monitored at a central data center.

It is a still further object of the invention to provide a monitoring appliance containing a sophisticated firewall to minimize any possibility of hacker intrusion through a WAN connection of the monitoring appliance.

It is yet another object of the invention to provide a monitoring appliance which has sophisticated intrusion detection features.

It is an additional object of the invention to provide a monitoring appliance that provides sophisticated network services such as, but not limited to: web hosting, file server, print server, virtual private network (VPN), shared Internet access, web content filtering, anti-virus, spam e-mail elimination, IP telephony services, intrusion detection, routing, DHCP, e-mail, DNS server, Web proxy, and backup.

It is a further object of the invention to provide a monitoring appliance that may be remotely upgraded.

It is yet another object of the invention to provide a monitoring appliance that monitors network configuration parameters, stores these parameters locally, and transmits these parameters to a central data center or other remote monitoring facility.

It is an additional object of the invention to provide a system where in the event of a failure of a monitoring appliance, configuration and network parameters stored at a central data center may be used to configure a replacement monitoring appliance which may then be shipped to the customer or other end user site and installed by non-technical personnel without disrupting any functions on the network to which it is connected.

### BRIEF DESCRIPTION OF THE DRAWINGS

A complete understanding of the present invention may be obtained by reference to the accompanying drawings when considered in conjunction with the subsequent detailed description, in which:

FIG. 1 is a schematic, system block diagram of the monitoring appliance of the invention in its intended operating environment; and

FIG. 2 is a screen shot of a display at the remote data center showing the status of several monitored networks.

### DETAILED DESCRIPTION OF THE PREFERRED EMBODIMENT

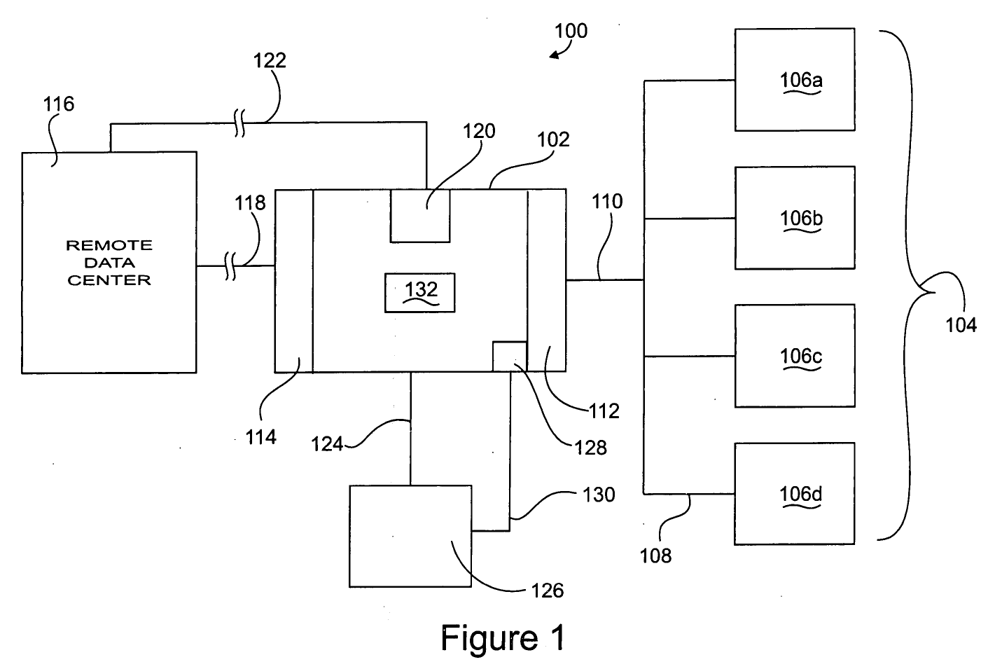

Referring first to FIG. 1, there is shown an environmental, schematic block diagram of the monitoring appliance 102 (hereinafter simply called appliance) in a typical operating environment, generally at reference number 100. Appliance 102 is connected to a computer network 104 represented by devices 106a, 106b, 106c, 106d, typically computers, workstations, or other similar devices connected to one another by the backbone 108. Devices 106a, 106b, 106c, 106d, on the network 104 are connected to appliance 102 via a network connection 110 by means of a first computer interface 112. The first computer interface 112 is, functionally speaking, the network attachment interface of appliance 102. It will be recognized that the backbone 108 represents any communications strategy and/or network topology known to those of skill in the computer networking arts that may be used to connect computers or other devices.

The present invention is not considered limited to any particular computer networking strategy but is seen to encompass any network strategy, wired or wireless, either currently known or which may become known in the future, the network topology forming no part of the present invention. For purposes of disclosure, an Ethernet network is assumed and intra-network communication is assumed to be performed using a TCP/IP communications protocol. The first computer interface 112 must, of course, be compatible with the computer network 104. Consequently, for purposes of disclosure, the first computer interface 112 is assumed to be an Ethernet interface. It will be recognized that any network interconnection interface, either known or yet to be invented, may be used to connect appliance 102 to the network. Consequently, the invention is not considered limited to the Ethernet connection chosen for purposes of disclosure.

A second interface 114 is provided to allow communications with a remote site, typically a remote data center 116 via a communications link (e.g., a wide area network or WAN) 118. Any known technology may be used for establishing a datalink 118 between the second interface 114 of appliance 102 and a remote data center 116. Typical datalinks 118 may be implemented via the Internet (not shown) using a cable modem (not shown), a digital subscriber line (DSL) and an appropriate modem (not shown), a dedicated connection, a dial-up connection, an RF link such as a low-frequency (i.e., non-microwave) RF link, or a microwave link, a laser communications link, an infrared (IR) communications link or any other type of communications like, either now known or yet to be developed. Because the operation of the inventive network monitoring appliance is independent of the type of communications link used, the invention is not considered limited to the particular data communications links chosen for purposes of disclosure.

While the preferred embodiment of the invention employs a monitoring center which is remote to the customer's monitored LAN, it will be recognized that other arrangements are also possible and may be required to meet a particular operating requirement or environment. For example, if a particular customer has multiple monitored networks, it may be desirable to locate a dedicated “remote” monitoring facility physically at one of the customer's facilities having one of the monitored networks. In other words, the “remote” monitoring center is not necessarily remote to one of the monitored networks but is, however, remote to the remainder of the customer's monitored networks. The present invention seems to encompass this and any other arrangement of monitored computer networks and remote monitoring centers.

Because transmitted data is typically encrypted, security of the communications link 118 is not usually an issue and any datalink 118 providing the necessary communications bandwidth (i.e., providing enough communications capacity) may be used. Either a cable or DSL modem (coupled to its respective communication infrastructures) and the Internet have been found to be particularly satisfactory for the application.

An internal modem is provided as a back-up communications link between appliance 102 and the remote data center 116. Typically, only the remote data center 116 initiates communications with appliance 102 via a dial-up telephone link 122 and a modem 120. Typically, for security reasons, the modem 120 is not permanently connected to the dial-up telephone network but is temporarily connected only when communications are required.

Electrical power is supplied to appliance 102 via a power cable 124, typically from an uninterruptible power supply (UPS) 126. The use of a UPS 126 allows appliance 102 to shut down in an orderly manner in the event of an AC power problem. A data connection 130 between the UPS 126 and the UPS port 128 on appliance 102 is provided to allow appliance 102 to monitor incoming power, the UPS 126 battery condition, etc.

Central to appliance 102 is a controller or processor 132, which, as would be expected, is functionally connected to all internal components of appliance 102. The processor 132 is typically a microprocessor and has all necessary support circuitry, sub-systems, etc., as will be recognized by those of skill in the computer arts as being required to form a processor.

As may be seen, appliance 102 becomes part of the network 104, which it monitors and, typically, all contact between the network 104 and the outside world is through appliance 102. Consequently, all communication with the remote data center 116 is under the control of appliance 102. Therefore, all network security may be managed by appliance 102 and, consequently, no holes are left in the interface to the outside world through which a hacker might obtain access to the computer network 104 or to any of the devices 106a, 106b, 106c, 106d attached thereto.

An exemplary embodiment of appliance 102 is constructed around a standard computer motherboard housed in a standard computer case having a standard power supply for supplying the low voltage requirements of the motherboard, none of which are shown. The first computer interface 112 and second computer interface 114 are typically Ethernet adapters provided by motherboard resources, plug-in cards or modules, or a combination of both. Typically, a microprocessor chip and memory are directly plugged into the motherboard. While the operation of appliance 102 will be described in detail hereinbelow, it is designed to place relatively low demands on the processor 132. Consequently, a processor having speed well below state-of-the art may be used. Processors in the clock speed range of approximately 500 MHz may be used.

Likewise, the modem 120 is either an on-board modem or a plug-in card or module. A 56 Kbit modem has been found satisfactory for the application, although modems operating at other communications speed may also be used.

The UPS monitoring port 128 is typically a Universal Serial Bus (USB) port, also typically provided on the motherboard. If unavailable on the motherboard, USB plug-in cards or modules may also be used. It will be recognized that interfaces other than USB (e.g., serial, firewire, etc.) may be used to establish monitoring communication between the UPS 126 and appliance 102 as required to operate with a particular UPS 126.

A hard disk or other such random access read-write storage device is also provided as part of appliance 102. The term hard disk is used hereinafter to represent any such non-volatile, read-write storage device. Storage requirements are relatively small and, consequently, small hard drives or the like may be used. A hard disk size of approximately 40 Gbytes has been found satisfactory. However, because network configuration information is to be maintained in the hard disk, reliable operation of appliance 102 requires high reliability storage. In the preferred embodiment, such reliable storage is provided by a plurality of mirrored, hard disk drives implementation. Such implementation may be provided by software and may require no special hardware. In alternate embodiments, a Redundant Array of Independent (or Inexpensive) Disks (RAID) system may be used. RAID is a category of disk drive subsystems that employs two or more drives in combination for fault tolerance and performance. There are a number of different RAID levels.

The preferred RAID configuration is RAID Level 1 but other techniques such as another level of RAID may also be used to meet a particular operating circumstance or environment. In addition, SMART hard disk technology is ideally used so that hard drive performance may be readily monitored. Mirroring, RAID, or SMART techniques are not required but the inclusion of one or more of these techniques improves the reliability of the inventive appliance 102.

Typically, appliance 102 has no other interfaces or attached devices. For example, there is no diskette drive, no keyboard and no monitor used, even for setting up appliance 102. In fact, typically there is not even a power on-off switch provided.

While a single monitoring appliance connected to each individual monitored computer network 104 is generally satisfactory for many applications, it is possible to provide a backup monitoring appliance, not shown, running in tandem to a primary monitoring appliance 102. While a failure of the single monitoring appliance 102 of the preferred embodiment typically will not cripple a customer's operation, there are some installations where this is not the case. Consequently, a backup (either “hot” or on standby) monitoring appliance may be provided with a suitable mechanism, not shown, used to switch from a primary to a secondary monitoring appliance. Such mechanisms are understood by persons of skill in the art and will not be further explained herein.

All components will be recognized by those skilled in the computer integration and/or repair arts as readily available, off-the-shelf components, all well known to those of skill in the art; they are not further described herein.

In operation, appliance 102 forms part of an extremely sophisticated, centralized monitoring system. First, appliance 102 self-monitors its internal parameters such as processor performance, DC bus voltages, fan speeds, internal temperatures, CPU temperature, and disk performance (especially hard disk error statistics from the SMART sub-system). In addition, the condition of the AC power is monitored via the UPS 126. The condition of the UPS battery (not shown) is also monitored and the power (i.e., operational time) remaining in the battery is easily estimated. It will be recognized that other sensors and/or other conditions may be included and monitored as well. The invention is, therefore, not considered limited to the exemplary sensors, conditions, and parameters chosen for purposes of disclosure.

Network operating conditions are also continuously monitored by appliance 102. Applications (i.e., application software as well as other processes) and available network resources such as network connectivity, storage devices, printers, etc. are all monitored by appliance 102. The number of connected users is also monitored and this information may be used to determine license (i.e., subscription) compliance. The terms license and subscription are used interchangeably herein. Appliance 102 acts as a primary gateway router for the remote network 104 and, optionally, may offer additional server-related services (i.e., network services traditionally offered by a network server). Because all network traffic is broadcast to, directed to, or directed through appliance 102, appliance 102 may manage, track, and respond to all network traffic, e-mails, viruses, network error conditions, outages, non-responsive server services, attacks, authentication requests, and other network-related conditions.

Appliance 102 analyzes network traffic and traffic levels and may simply report, take an action, or redirect traffic for further analysis. Appliance 102 may drop, pass, mangle, manipulate, or redirect network packets on the fly. Appliance 102 may address problems or make configuration changes as required. For example, in prior art networks not connected to appliance 102, each computer or other network device 106a, 106b, 106c, 106d needs to be custom configured to use a new server or to implement a new server service. However, with appliance 102 connected to a network 104, appliance 102 may simply capture packets and redirect them to or from another server or server service such as a proxy server, e-mail server, anti-virus scanner, or even a telephone system or the like. The entire redirection process is hidden from any individual device 106a, 106b, 106c, 106d. The entire network 104 may, therefore, be transparently reconfigured without any need to reconfigure any individual computer or other device 106a, 106b, 106c, 106d.

This packet redirection technique allows monitoring or managing anything that communicates across the network. The possibilities are essentially unlimited. For example, all e-mail may be redirected through anti-virus and/or anti-spam systems, either presently existing or systems which may be developed in the future. Appliance 102 can generate reports regarding network traffic. Low priority traffic may be throttled in time of high resource demand. Traffic directed to a “broken” server may be redirected to another server on the fly.

The addition of a small application program (i.e., client program) to computers or workstations 106a, 106b, 106c, 106d attached to the network 104 allows granular monitoring of hardware and/or software resources on any network device 106a, 106b, 106c, 106d.

The result of all monitoring activity is periodically forwarded to a remote data center 116. The monitoring process at the remote data center 116 is described in detail hereinbelow.

It will be recognized that the logical placement of appliance 102 in the overall topology of the network 104 functionally positions appliance 102 in a manner similar to a conventional network server, not shown. In fact, appliance 102 may be configured to provide some specific network services normally provided by such a conventional network server.

A list of the services which may selectively be provided by appliance 102 includes but is not limited to: Dynamic Host Configuration Protocol (DHCP), Domain Naming Service (DNS), Network TCP/IP routing, firewall services, intrusion detection, stateful packet inspection, e-mail service, e-mail spam-scanning, e-mail and/or internet anti-virus scanning, file sharing service, printer sharing service, SSH-encrypted terminal and tunnel support, VPN service, web server to host client web site, web proxy support, Internet content filtering service, browser-based web-mail, and scheduling. Each of these optional services may be remotely, selectively enabled and disabled.

In operation, typically a customer or other user first subscribes to the novel monitoring service based around the network-monitoring appliance 102. The customer then provides basic network configuration information to the monitoring service provider to allow pre-configuration of a monitoring appliance 102 which, when pre-configured, is shipped to the customer. The user IDs and passwords of all users are also provided as well as e-mail addresses for each user. The workgroup name, if other than WORKGROUP is also specified in the configuration supplied by the client to the service provider. In addition, the IP address assigned by the Internet Service Provider (ISP) is required for pre-configuration of appliance 102. It may be possible or desirable to obtain additional information, for example, machine IP addresses from the customer and even more pre-configuration may possibly be done. It will, of course, be recognized that the monitoring appliance 102 may be supplied to an end user under a variety of other business models. The monitoring appliance 102 could, for example, be purchased outright, leased, or otherwise procured. Monitoring services could then be supplied under business relationships other than the subscription arrange chosen for purposes of disclosure. The invention is seen to include any alternative business arrangement under which either the inventive hardware or monitoring method may be supplied to any end user thereof. The term customer is used hereinafter to represent any end user of the inventive monitoring appliance and/or monitoring services regardless of how either are procured.

In alternate embodiments, a “raw” appliance 102 could be shipped to a customer site and totally configured from the remote data center 116 over either the WAN connection 118 or the dial-up interface. Consequently, the invention is not considered limited to either a pre-configured or a non-configured configuration, or to any particular level of pre-configuration.

The appliance 102 is then shipped by any suitable carrier to the customer site with simple installation instructions. Typically, installation consists of unplugging a network cable from a broadband modem (e.g., cable, DSL, etc.) and connecting a cable from the clearly labeled WAN port of appliance 102 to that modem. A second cable is connected from the LAN port of appliance 102 to any open port on a hub or switch, which is connected to the customer's computer network 104.

An uninterruptible power supply (UPS) 126 is typically used with appliance 102. The UPS 126 is connected to a source of electrical power and appliance 102 is plugged into the UPS 126. There is typically no power on-off switch associated with appliance 102 to eliminate one possible source of problems. A data connection 130, typically USB, is made between appliance 102 and the UPS 126 via a cable 130.

Once the WAN, LAN, and power connections have been made, appliance 102 is fully functional and immediately begins its monitoring functions.

In the rare event that a pre-configuration problem is encountered, a telephone connection may be temporarily established between the remote monitoring facility 116 and a modem 120 within appliance 102 and the problem may be quickly rectified from the remote monitoring facility 116.

Once in place, appliance 102 immediately begins its tasks of self-monitoring, network 104 monitoring, and monitoring other computers and/or devices 106a, 106b, 106c, 106d on the network 104. In addition, if configured to do so, appliance 102 begins providing any selected network services. One of the most important services is routine periodic backup of designated data to a predetermined machine on the monitored computer network 104. Unless otherwise specified, a local machine will be used for backup. It will be recognized that many alternate backup devices exist and may effectively be used to provide network backup. Devices such as tape, CDR, CDRW, DVDR, DVDRW, and USB-attached devices such as external hard disks, non-volatile semiconductor memory devices, etc. may all be used and the invention is not considered limited to any particular backup media or location.

One of the many conditions monitored by appliance 102 is the status of the designated machine to which backups are directed. For example, if the target machine or other backup device is shut down, that fact is noted at the remote data center 116 and an appropriate action may be taken. If the backup is of a critical nature, communication with the monitored site may be initiated, automatically or manually, and the target backup machine or other backup device may be turned back on by personnel at the monitored site. In alternate embodiments, a designated backup machine may be remotely turned on from the remote data center 116 using the wake on LAN (WOL) feature widely available in network workstations.

Appliance 102 confirms that a designated backup has actually taken place and a true backup of the designated data actually exists. This particular monitoring action is present because of numerous incidents regarding backups that supposedly were completed satisfactorily when, in fact, a tape or other backup volume was defective and nobody knew that the backup had not actually been performed until the supposedly backed up data was needed to restore a critical system.

Again it should be noted that the backup has been performed completely at the monitored network; no data has been transferred across the WAN 118 to the remote data center 116. The backup, however, has been “pushed” from the remote data center 116 and, as described above, monitored to ensure a successful backup outcome. Because no data has been transmitted across the WAN 118 used by the remote data center 116 to monitor the network 104, no data security issues have been raised. Also, sending possibly large amounts of data across the WAN 118 requires time and consumes communications bandwidth, both possibly adding significant cost to the monitoring infrastructure, which is avoided by the inventive method.

Yet another problem avoided by the distributed, managed network topology of the invention is that there is no single point of failure which may bring down all of the managed networks 104 connected to the remote data center 116. All of these problems are avoided by the innovative design of appliance 102 and the novel system supporting appliance 102.

As previously stated, appliance 102 is capable of providing network services in a manner similar to a traditional network server. One of the network services provided is TCP/IP packet routing, scanning, and monitoring. Health issues regarding data communication within the network 104 may be determined by monitoring TCP/IP packets. In particular, the levels of errors may be easily tracked and reported.

Appliance 102 may act as a router and provides shared Internet access. Because appliance 102 is the only point of contact with the WAN 118 (e.g., the Internet), appliance 102's sophisticated firewall protects the network 104 in a highly effective manner. One of the firewall techniques used by appliance 102 is stateful inspection, sometimes called dynamic packet filtering. Stateful inspection is a firewall architecture that works at the network layer. Unlike static packet filtering, which examines a packet based on the information in its header, stateful inspection tracks each connection traversing all interfaces of the firewall and ensures they are valid. For example, a stateful firewall may examine not just the header information but also the contents of the packet up through the application layer in order to determine more about the packet than just information about its source and destination. A stateful inspection firewall also monitors the state of the connection and compiles the information in a state table. Because of this, filtering decisions are based not only on administrator-defined rules (as in static packet filtering) but also on context that has been established by prior packets that have passed through the firewall.

As an added security measure against port scanning, stateful inspection firewalls close down ports until connection to the specific port is requested.

Another security feature of the firewall portion of appliance 102 is IP masquerading that allows one or more computers in the network 104, which may not have assigned IP addresses to communicate with the Internet using the appliance's 102 assigned IP address. Appliance 102, therefore, acts as a gateway, and any other devices 106a, 106b, 106c, 106d connected to the network 104 are invisible behind it. On the Internet, the outgoing traffic appears to be coming from appliance 102 and not individual devices (i.e., computers) 106a, 106b, 106c, 106d.

Still another security provision provided by appliance 102 is network address translation (NAT) that enables the network 104 to use one set of IP addresses for internal communication and a second set of IP addresses for external communication (i.e., Internet). Appliance 102 therefore acts, among other things, as a “NAT box” that makes all necessary IP address translations. NAT serves three main purposes: it enhances firewall performance by hiding internal IP addresses, it allows an organization to use more internal IP addresses because the addresses only appear internally; consequently, there is no possibility of conflict with IP addresses used by other companies and organizations, and NAT allows an organization to combine multiple ISDN connections into a single Internet connection, unlike the prior art.

Appliance 102 contains many sophisticated security and intrusion detection provisions. For example, appliance 102 tracks network configuration changes and stores the current network information in a configuration database (not shown). This configuration database contains such information as user accounts, passwords, firewall settings, spam-filtering configurations, Internet browser content filtering configurations, and special routing instructions, as well as any other unique customer settings. This information is periodically compared to the actual system configuration. Such a comparison is a useful tool for detecting intrusion. The comparison is typically performed at least once a day. As already stated, the database is replicated at the remote data center 116. Because users are prevented from making any core system changes, any unauthorized changes thereto trigger an intrusion alert at the remote data center 116. This prevents the possibility of a hacker's work going unnoticed. Another way in which intrusion detection may be accomplished is by maintaining a database of all system file attributes. Files that should not be changed during the normal course of operation of the network 104 may be periodically compared, for example, on a daily basis. Yet another way by which intrusion may be detected is by maintaining a log of log-in attempts. The log may be analyzed to detect patterns such as multiple log-in attempts. There are other intrusion detection methods that may also be implemented and the invention is not considered limited to the two specific methods chosen for purposes of disclosure.

The benefits of proxy servers are well known. Appliance 102 may be configured to selectively provide such proxy services to the network 104, either in lieu of or in addition to network service provided by a traditional server or other server-like device.

Yet another service available from appliance 102 is Internet content filtering. Content filtering is useful for removing access to objectionable web sites or for stopping material having objectionable words or phrases from reaching users. Content filtering is usually provided only by add-on software packages and is normally provided on a machine-by-machine basis. The inclusion of this useful tool saves both the purchase price of additional software and places most administrative controls at a central location so that all machines connected to the network 104 are covered (i.e., protected).

Another available network service is domain name service (DNS) hosting. DNS is a service that translates domain names into IP addresses. Because domain names are alphabetic, they are generally easier to remember than raw IP addresses. The Internet however, is really based on such IP addresses. Every time a domain name is used, a DNS service must translate that name into a corresponding IP address. These DNS services are performed by appliance 102.

Also provided by appliance 102 are dynamic host configuration protocol (DHCP) services. DHCP is used in dynamic addressing situations wherein each time a device connects to a network, that device may be assigned a different IP address by the DHCP service.

Computer and/or IP telephony related communications features of appliance 102 provide data and/or voice services across the WAN 118. These features allow low-cost voice or data communications throughout the world via the WAN 118 (i.e., the Internet) without the need for any additional hardware or software.

In addition, appliance 102 provides e-mail services including post office protocol (POP3), simple mail transfer protocol (SMTP), and light directory assistance protocol (LDAP). These services are usually only provided by expensive, add-on hardware or software products. Appliance 102 provides a web mail system for simpler local or remote access to e-mail.

Web hosting services are still another network service provided by appliance 102. In keeping with the overall theme of simplicity, at least from a user's perspective, appliance 102 provides a preconfigured web folder. Web content dragged and dropped into this web folder is automatically properly posted and administered as a web site thereby freeing the user from needing any skills other than content generation skills. Web pages generated by a third party may be easily “brought up” using this novel feature provided by appliance 102.

Anti-spam services are also provided by appliance 102. Because anti-spam black lists are centrally maintained at the remote data center 116, as a spammer is identified, all sites (i.e., networks 108) monitored from the remote data center 116 may be automatically updated. Of course, individual white lists allow e-mail traffic that may be spam to one site to be allowed at another site where the e-mail is not considered spam.

Like the anti-spam provision provided by the novel appliance 102, antiviral protection of e-mail and shared files is centrally administered. Consequently, as a new virus pattern is detected, the new pattern file may be easily provided to all monitored sites so that, if desired, all sites are automatically protected by the latest anti-virus patterns.

File sharing and other server message block (SMB) protocol support features are provided by appliance 102. The supported features include the support of network attached storage (NAS). SMB-based services are important in that they allow easy cross-platform communication without the necessity of third-party add-on products to provide such communication.

Appliance 102 typically provides fully redundant storage of user data. In addition to remotely pushed backup of user data, appliance 102 stores system parameters such as account names, passwords, IP addresses, spam and firewall rules, routing information, e-mail configurations, content scanning rules, e-mail white lists and black lists, etc. remotely (i.e., at the remote data center 116). It will be recognized that many other system and/or user parameters could be stored by appliance 102 and the invention is not, therefore, considered to be limited to the specific system and user parameters chosen for purposes of disclosure.

Still another network service provided by appliance 102 is shared printing support using both SMB and network attached print servers. Appliance 102 can queue print jobs and serve them to network printers, thereby providing a control point for print jobs.

Virtual Private Networking (VPN) support using either IP security set (IPSEC) or point-to-point tunneling protocol (PPTP) methodologies is provided. A VPN is a private network of computers that uses the public Internet to connect some network nodes. IPSEC supports two encryption modes: transport and tunnel. Transport mode encrypts only the data portion (payload) of each packet, but leaves the header untouched. The more secure tunnel mode encrypts both the header and the payload. On the receiving side, an IPSEC-compliant device decrypts each packet.

For IPSEC to work, the sending and receiving devices must share a public key. Public key management is typically accomplished using a protocol known as Internet Security Association and Key Management Protocol/Oakley (ISAKMP/Oakley), which allows the receiver to obtain a public key and authenticate a sender using digital certificates.

PPTP is used to implement VPNs because the Internet is essentially an open network. PPTP ensures that messages transmitted from one VPN node to another via the Internet are secure. For example, using PPTP, users can dial into their corporate network from a remote location via the Internet.

It will be recognized by those of skill in the art that any mix of the foregoing network services may be provided and that other network services may be readily added to the functionality of appliance 102. Consequently, the present invention is not considered to be limited by those particular network services chosen for purposes of disclosure but rather is seen to encompass any services providable by a server-type apparatus within a computer network.

As has been discussed hereinabove, the inventive appliance 102, in cooperation with a WAN 118 and a remote data center 116, advantageously provides many services. For example, data backups may be pushed from the remote data center 116. In a similar manner, anti-virus scans may also be pushed. As described hereinabove, secure, encrypted terminal and tunnel sessions for remote support of nodes is provided. The remote data center 116 serves as a central repository of all configuration data and user information associated with each appliance 102 connected to the network 104.

Automated universal or selective upgrades of appliance 102 deployed remotely from a remote data center 116 may be readily performed. Such upgrades may include both improvements to existing functionality, or entirely new features. The design of appliance 102 is such that it is expandable, reconfigurable, and enhanceable to incorporate new and future technologies. Using the subscription business model wherein no customer outrightly purchases an appliance 102, there is no problem of obsolescence as appliances 102 may be routinely upgraded and updated by the service provider.

However, it is impossible to overstress the advantages of the predictive failure analysis, monitoring and repair of all provided network services, and the automated reporting features of the inventive system. Because of the vast network experience of the inventors of appliance 102 and the surrounding system, many network problems, both common and uncommon, have been dealt with and known solutions already exist. Coupled with the philosophy that no human should be required in the repair loop if an automated procedure may be implemented to deal with a problem, appliance 102 has been created to facilitate automated diagnosis and repair. The term “computer technician” takes on a literal significance in the system of the present invention in that a computer IS the technician most of the time.

The monitoring process in place at the remote data center 116 is both simple and sophisticated. First, multiple remote data centers may be provided and it will be recognized that any appliance 102 at any monitored site may be monitored by more than one remote data center 116. Each remote data center 116 is typically equipped with multiple connections to the Internet or other WAN interconnecting remote sites and their respective appliances 102. Connections may be combinations of T1 lines, ISDN connections, cable modems, DSL connection and any other known WAN or Internet connection in any combination. The reason for multi-mode redundancy is to maintain data communication with remote sites encompassing the widest possible range of communications difficulties.

Data periodically transmitted from all appliances 102 at all monitored sites is first collected by redundant monitoring servers (not shown) at the remote data center 116 and the data is quickly converted into web pages which may be securely viewed by any authorized person at any authorized location. The web-enabled data displays are immediately viewable by a large number of support technicians, either at the remote data centers 116, or located remotely therefrom. Data is typically transmitted between about every one and five minutes but the transmission interval may be varied to accommodate a specific operating circumstance or environment.

The monitoring servers at the remote data centers 116 compare specific incoming data to a profile for a respective site. Each site may have different features active or different monitored processes. If incoming data indicates an out-of-range value or a problem of any nature, a variety of actions may be taken, depending upon the apparent severity of the problem. In many cases, appliances 102 at the monitored sites may already have taken appropriate remedial action and by the time the status information is transmitted from appliance 102 to the remote data center 116, there is a high probability that, at least for certain classes of problems, the problem has already been resolved.

Because the inventive system heavily relies on predictive failure analysis, many indications observed by the monitoring servers require no immediate action. In other cases, warnings of suspected approaching failures may trigger preemptive intervention. For example, a monitored network process may be behaving in a suspicious manner. Assuming that all monitored hardware resources involved with the failing process are indicating a satisfactory status, the suspect process may be stopped and restarted, generally automatically, either by appliance 102 or, in other cases by automatic or manual intervention from the remote data center 116.

For other classes of problems, however, immediate action may be required. The data-based web pages created by the monitoring servers provide a visual indicator of a malfunction or suspicious state of many monitored parameters for each remote appliance 102. Red alerts are immediately observable by a monitoring technician. In addition to visual alerts, the monitoring system has other options. For example, if a problem is not acknowledged within a predetermined amount of time, audible alarms, e-mail notifications, cell phone or pager alerts or notification by any other suitable means may be sent to an appropriate technician.

Many malfunctions in appliance 102, itself, may be predicted and a replacement appliance 102 pre-programmed from stored, dynamically updated configuration information may be shipped to the client site. The pre-programmed appliance may be shipped by any suitable means including overnight air freight as required. As previously described, the installation of the appliance consists of connecting two data cables, a power connection and a UPS data connection. The replacement appliance 102 is ready to go out of the box and the possibility of any installation problem is negligible.

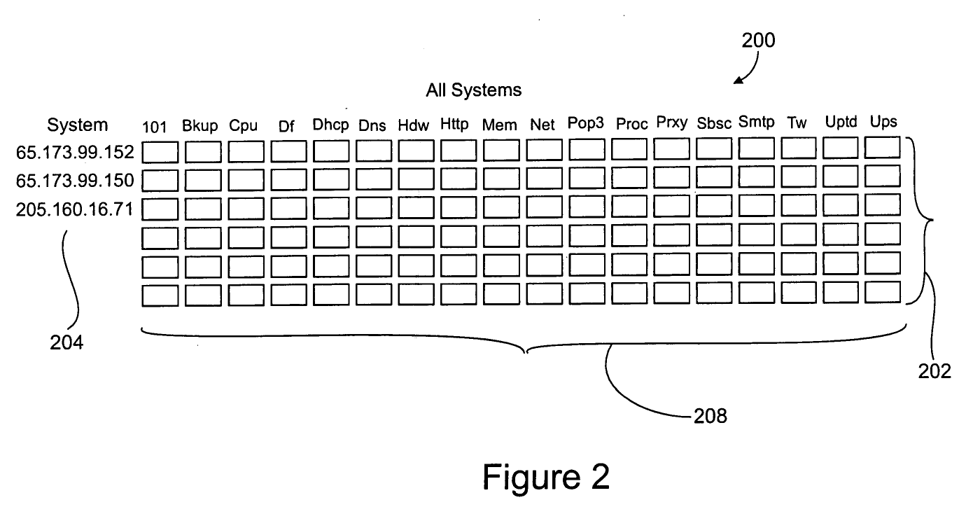

The secure web pages generated by the monitoring servers may be displayed at any number of support technician terminals. Referring now also to FIG. 2, there is shown a general monitoring screen displaying the status of, for purposes of clarity, only three monitored systems (i.e., remote appliances 102 connected to respective computer networks 104), generally at reference number 200. While it will be recognized that data from remote appliances 102 may be graphically presented in a wide variety of formats, the screen shot of FIG. 2 shows one such graphical display. Screen 200 is one screen from the inventors' Netstream™ implementation of the novel system. While the screen from Netstream™ may be used for purposes of disclosure, it will be recognized that many other implementations of the inventive concepts may be realized.

It will be recognized that many problems and/or potential problems are resolved and/or prevented entirely behind the scenes from a customer perspective. Consequently, it is possible for a customer to be unaware of the value being received from the inventive monitoring appliance and monitoring service. The remote monitoring center compiles such statistics for internal purposes and may readily generate and provide reports-to individual customers detailing the number and types of problems resolved or prevented during a particular time interval. The tracking of recurrent problems may have a secondary benefit to a customer in that such information may indicate misuse of customer equipment and/or employee sabotage.

Each monitored system is represented by a row of status boxes 202. A “system” column 204 displays the IP addresses of the three monitored systems. It will be recognized that a label for each monitored system may be displayed in lieu of the IP address. Each status block 206 in the columns 208 represents the status of a monitored parameter. In the embodiment chosen for purposes of disclosure, each status block 206 may display one of five colors: green indicates that the monitored parameter or function is normal, white indicates that the particular parameter is not monitored in that particular system, purple indicates that the particular system is not on, yellow indicates that while a significant error has occurred, the device or process is still functioning, and a red indication means there is a severe problem and something is not working. It will be recognized that these or other colors or geometric symbols may be used, and those mentioned are merely illustrative.

In the embodiment chosen for purposes of disclosure, 18 information categories are displayed on the screen 200. Screen headings for the columns 208 are: 101, Bkup, Cpu, Df, Dns, Hdw, Http, Mem, Net, Pop3, Proc, Prxy, Sbsc, Smtp, Tw, Uptd, and Ups. Each of these information categories is explained in detail hereinbelow.

The column 208 labeled “101” indicates whether the network machine designated for performing system backups is operational. “101” is chosen because, unless otherwise specified, the network machine having an IP address 192.168.111.101 is the designated backup machine. If the backup machine (i.e., “101”) becomes unavailable, backups cannot be performed and a technician may take whatever steps necessary depending upon the particular client. If wake on LAN (WOL) is available, the machine “101” may be turned on from the remote data center 116.

The column 208 headed “Bkup” indicates whether the last backup attempt was successful.

The column 208 labeled “Cpu” indicates whether appliance 102's CPU has an excessive load.

The column 208 labeled “Df” indicates the amount of disk space available, an insufficient amount of disk space creates an error or warning indication.

The column 208 labeled “Dhcp” indicates the condition of the DHCP service.

The column 208 labeled “Dns” indicates the status of the DNS service.

The column 208 labeled “Hdw” indicates whether there are any hardware problems with appliance 102. Representative problems may include temperature, voltage, disk errors, etc.

The column 208 labeled “Http” indicates the operational status of the web site (if present) as part of the monitored network.

The column 208 labeled “Mem” indicates the status of memory usage within appliance 102.

The column 208 labeled “Net” indicates the status of network traffic.

The column 208 labeled “Pop3” indicates the status of the e-mail POP3 system.

The column 208 labeled “Proc” indicates the status of various running processes, specifically, the quantity of running processes. Appliance 102 may allow additional SMTP processes to spawn, for example, additional e-mail processes during a time period when monthly (or other periodic) billing statements are being e-mailed to the customer. However, if an excessive number of SMTP process is found, that condition, possibly indicative of a spammer's illegal work, creates a Proc error condition.

The column 208 labeled “Prxy” indicates the status of the web proxy server.

The column 208 labeled “Sbsc” monitors the number of computers, workstations, etc. connected to the monitored network and compares the count to the subscription limit. An Sbsc indication is provided when the subscription count is exceeded.

The column 208 labeled “Tw” (tripwire) provides an error indication if an illegal system change is detected.

The column 208 labeled “Updt” alerts a technician if a problem is encountered with a system update or if out-of-date software is encountered. Monitored software includes anti-virus updates, software patches, etc.

The column 208 labeled “Ups” encompasses the UPS and its batteries. A UPS error indication may be provided in the event of a poor power condition at the customer's site.

It will be recognized that other conditions, parameters, or subsystems may be monitored and that monitored results may be provided in other ways than are shown on the screen 200 for purposes of disclosure.

The monitoring system typically displays the rows 204 representing monitored systems with the system having the most critical problem shown in the top row. This display arrangement allows a monitoring technician to identify problems in order of severity. It will be recognized that other arrangements of data display may also be used. Regardless of the display arrangement, a support technician may readily see which systems are experiencing abnormal behavior.

The remote data centers 116 are typically provided with both UPS systems to handle short-term power outage problems as well as backup generation equipment to provide power during longer-term power interruptions.

It is anticipated that the inventive system including novel appliance 102 and a monitoring service at a remote data center 116 will be provided to clients on a subscription basis for a periodic (e.g., monthly, quarterly, annual, etc.), all-encompassing fee. Therefore, no up-front capital expenditure is required. Consequently, the many advantages of the novel system are available to very small businesses, which normally could not afford the offered features. A subscribing client is relieved of any need for tracking licenses, periodically upgrading software and/or hardware, and of providing a tech support staff. It will be recognized, however, that other billing/payment arrangements such as a one-time payment are possible and the present invention is seen to encompass alternative payment arrangements including a one-time payment option.

The interests of the provider are well protected under this model as monitoring services and all in-the-appliance 102 network services may be suspended from the remote data center 116 if a client fails to pay the ongoing subscription fee. Because the novel system tracks the actual number of users, the addition of a user that exceeds the number of contracted users is readily known by the service provider. The client may then be automatically billed for the extra users or, if the client is unwilling to pay, services may be denied to users in excess of the contracted number. The service supplier handles all replacements due to appliance 102 hardware failure, obsolescence, etc. Customer damage may be handled under a different provision of a service agreement.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of providing remote computer network monitoring, the steps comprising:
a) obtaining network configuration information for a computer network to be remotely monitored, said computer network being associated with a customer;
b) pre-configuring a network-monitoring appliance using configuration information comprising at least a portion of said network configuration information obtained in said obtaining step (a);
c) providing said pre-configured network-monitoring appliance to said customer;
d) installing said pre-configured network-monitoring appliance in said computer network associated with said customer to create a monitored computer network;
e) providing a remote monitoring center operatively connected to said network-monitoring appliance via a data communications link;
f) receiving, at said remote monitoring center, information from said network-monitoring appliance via said data communications link;
g) performing at said remote monitoring center at least one of the operations: storing at least a portion of said received information, storing information representative of at least a portion of said received information, performing at least one statistical operation on at least a portion of said received information, comparing at least a portion of said received information with a predetermined parameter, reporting at least a portion of said received information and reporting information representative of at least a portion of said received information.

2. The method of providing remote computer network monitoring as recited in claim 1, wherein said network configuration information comprises at least one of the group: computer network user IDs, computer network user passwords, an IP address of a backup device, and an IP address assigned by an Internet Service Provider (ISP).

3. The method of providing remote computer network monitoring as recited in claim 1, wherein said providing step (c) comprises shipping said pre-configured network-monitoring appliance to said customer.

4. The method of providing remote computer network monitoring as recited in claim 1, wherein said installing step (d) is performed by said customer.

5. The method of providing remote computer network monitoring as recited in claim 1, wherein said installing step (d) comprises making at least one data connection to said network-monitoring appliance.

6. The method of providing remote computer network monitoring as recited in claim 5, wherein said installing step (d) further comprises making a power connection to said network-monitoring appliance.

7. The method of providing remote computer network monitoring as recited in claim 5, wherein said at least one data connection comprises at least one of the connections: a data connection to a data communications link, and a network data connection to said remotely monitored computer network.

8. The method of providing remote computer network monitoring as recited in claim 1, wherein said data communications link comprises at least one of the group: dedicated communication link, the Internet, a dial-up connection, an RF communications link, a microwave communications link, a laser communications link, an infrared (IR) communications link, and other communications link.

9. The method of providing remote computer network monitoring as recited in claim 8, wherein said data communications link comprises the Internet and at least one interface from the group: cable modem, and DSL modem, channel service unit/digital service unit (CSU/DSU), analog modem, dial-up modem, digital modem, and terminal service unit (TSU)

10. The method of providing remote computer network monitoring as recited in claim 8, wherein said data communication link comprises means for encrypting information transmitted thereby.

11. The method of providing remote computer network monitoring as recited in claim 1, wherein said network-monitoring appliance comprises means for providing at least one network service to said remotely monitored computer network.

12. The method of providing remote computer network monitoring as recited in claim 11, wherein said at least one network service comprises at least one of the network services: web hosting, file server, print server, virtual private network (VPN), shared Internet access, web content filtering, anti-virus, spam e-mail elimination, IP telephony services, intrusion detection, routing, DHCP, e-mail, DNS server, web proxy, and backup

13. The method of providing remote computer network monitoring as recited in claim 12, wherein said information from said network monitoring appliance comprises a status of at least one of: said at least one network service, said network monitoring appliance, and another device attached to said monitored computer network.

14. The method of providing remote computer network monitoring as recited in claim 12, wherein said intrusion detection process comprises at least a firewall.

15. The method of providing remote computer network monitoring as recited in claim 1, wherein said remote computer monitoring is provided by subscription to said customer.

16. The method of providing remote computer network monitoring as recited in claim 15, wherein ownership of said network-monitoring is retained by a party other than said customer.

17. The method of providing remote computer network monitoring as recited in claim 11, wherein ownership of said network-monitoring is retained by said customer.

18. The method of providing remote computer network monitoring as recited in claim 11, wherein said comparing at least a portion of said received information with a predetermined parameter sub-step detects a problem with at least one of: said network-monitoring appliance, said remotely monitored network, a device connected to said monitored network, and a network service running on said remotely monitored network.

19. The method of providing remote computer network monitoring as recited in claim 11, wherein said comparing at least a portion of said received information with a predetermined parameter sub-step predicts a problem with at least one of: said network-monitoring appliance, said remotely monitored network, a device connected to said monitored network, and a network service running on said remotely monitored network.

20. The method of providing remote computer network monitoring as recited in claim 18, the steps further comprising:
h) performing at least one of the steps in response to said detected problem: automatically correcting said detected problem, manually correcting said detected problem, and reporting said detected problem; and
i) optionally providing a replacement network monitoring appliance when one of the sub-steps of said performing step (h) fails to resolve said detected problem.

21. The method of providing remote computer network monitoring as recited in claim 1, wherein said remote monitoring center comprises at least two remote monitoring centers.

22. The method of providing remote computer network monitoring as recited in claim 1, wherein said computer network associated with said customer functions independently of said remote monitoring center such that performance of said network remain substantially unaffected by a failure at said remote monitoring center.

23. The method of providing remote computer network monitoring as recited in claim 1, wherein said monitoring appliance comprises a first, primary monitoring appliance and a second, backup monitoring appliance.

22. The method of providing remote computer network monitoring as recited in claim 1, the steps further comprising:
h) updating said network-monitoring appliance from said remote monitoring center.

23. The method of providing remote computer network monitoring as recited in claim 1, wherein said remote monitoring center is adapted to monitor a plurality of computer networks each of said computer networks being equipped with a respective network-monitoring appliance.

24. The method of providing remote computer network monitoring as recited in claim 1, wherein said receiving step (f) and at least one of said operations of step (g) comprise an inside-out monitoring process.

25. The method of providing remote computer network monitoring as recited in claim 1, the steps further comprising:
h) reporting information indicative of a status of at least one of: said network monitoring appliance, and a device connected to said monitored computer network.

26. The method of providing remote computer network monitoring as recited in claim 1, wherein said remote monitoring center is disposed proximate said monitored computer network.

27. A network-monitoring appliance to facilitate remotely monitoring a computer network, comprising:
a) a processor;
b) at least one interface operatively connected to said processor and adapted to communicate with at least one of: a monitored computer network, and a remote data center;
c) a storage device operatively connected to said processor and adapted to store at least configuration information associated with said monitored computer network;
d) means for monitoring at least one of: said appliance, at least one network service operating on said monitored computer network, and a device attached to said monitored computer network, operatively connected to said processor, said means for monitoring producing an output representative of an operational parameter of a monitored device or service; and
e) means for alerting operatively connected to said means for monitoring and responsive to said output therefrom, said alerting means producing an alert signal when said operational parameter is outside a predetermined, acceptable range of values, said means for alerting being operatively connected to said data center and adapted to provide said alert signal thereto via said at least one interface.

28. The network-monitoring appliance to facilitate remotely monitoring a computer network as recited in claim 27, further comprising:
f) a second interface, operatively connected to said processor and adapted to communicate with at least one of: a monitored computer network, and a remote data center.

29. The network-monitoring appliance to facilitate remotely monitoring a computer network as recited in claim 27, further comprising:
f) means for providing a network service to said monitored computer network.

30. The network-monitoring appliance to facilitate remotely monitoring a computer network as recited in claim 27, wherein said network service comprises at least one of the services: web hosting, file server, print server, virtual private network (VPN), shared Internet access, web content filtering, anti-virus, spam e-mail elimination, IP telephony services, intrusion detection, routing, DHCP, e-mail, DNS server, web proxy, and backup.

31. The network-monitoring appliance to facilitate remotely monitoring a computer network as recited in claim 27, wherein said data center is disposed at a remote location and comprises a remote monitoring center and said at least one interface is connected to said remote monitoring center via a data communications link.

32. The network-monitoring appliance to facilitate remotely monitoring a computer network as recited in claim 31, wherein said data communications link comprises at least one of the group: dedicated communication link, the Internet, a dial-up connection, an RF communications link, a microwave communications link, a laser communications link, an infrared (IR) communications link, and another communications link.

33. The network-monitoring appliance to facilitate remotely monitoring a computer network as recited in claim 31, wherein said at least one interface comprises at least one of the group: an Ethernet connection, an ISDN connection, a serial connection, and a parallel connection, USB connection, other network interface.

34. The network-monitoring appliance to facilitate remotely monitoring a computer network as recited in claim 27, further comprising:
f) a power supply comprising an uninterruptible power supply (UPS) comprising a battery, said UPS being connected to an external source of electrical power and comprising means for monitoring at least one of said external source of electrical power and said battery, said UPS being operably connected to said means for monitoring of said network-monitoring appliance.

35. The network-monitoring appliance to facilitate remotely monitoring a computer network as recited in claim 27, wherein said storage device comprises at least one hard disk drive.

36. The network-monitoring appliance to facilitate remotely monitoring a computer network as recited in claim 35, wherein said at least one hard disk drive comprises at least two hard disk drives disposed in a mirroring configuration.

37. The network-monitoring appliance to facilitate remotely monitoring a computer network as recited in claim 36, wherein said mirroring configuration comprises a RAID configuration.

38. The network-monitoring appliance to facilitate remotely monitoring a computer network as recited in claim 37, wherein said RAID configuration comprises a RAID Level 1 configuration.

39. The network-monitoring appliance to facilitate remotely monitoring a computer network as recited in claim 36, wherein said at least one hard disk drive comprises a hard disk controller.

40. The network-monitoring appliance to facilitate remotely monitoring a computer network as recited in claim 39, wherein said hard disk controller comprises a SMART hard disk controller.

41. The network-monitoring appliance to facilitate remotely monitoring a computer network as recited in claim 27, wherein said device attached to said monitored computer network comprises a client program installed and run thereon, said client program being adapted to interact with said means for monitoring.

34. The network-monitoring appliance to facilitate remotely monitoring a computer network as recited in claim 27, further comprising:
f) a power supply comprising an uninterruptible power supply (UPS) comprising a battery, said UPS being connected to an external source of electrical power and comprising means for monitoring at least one of said external source of electrical power and said battery, said UPS being operably connected to said means for monitoring of said network-monitoring appliance.

35. The network-monitoring appliance to facilitate remotely monitoring a computer network as recited in claim 27, wherein said storage device comprises at least one hard disk drive.

36. The network-monitoring appliance to facilitate remotely monitoring a computer network as recited in claim 35, wherein said at least one hard disk drive comprises at least two hard disk drives disposed in a mirroring configuration.

37. The network-monitoring appliance to facilitate remotely monitoring a computer network as recited in claim 36, wherein said mirroring configuration comprises a RAID configuration.

38. The network-monitoring appliance to facilitate remotely monitoring a computer network as recited in claim 37, wherein said RAID configuration comprises a RAID Level 1 configuration.

39. The network-monitoring appliance to facilitate remotely monitoring a computer network as recited in claim 36, wherein said at least one hard disk drive comprises a hard disk controller.

40. The network-monitoring appliance to facilitate remotely monitoring a computer network as recited in claim 39, wherein said hard disk controller comprises a SMART hard disk controller.

41. The network-monitoring appliance to facilitate remotely monitoring a computer network as recited in claim 27, wherein said device attached to said monitored computer network comprises a client program installed and run thereon, said client program being adapted to interact with said means for monitoring.

42. The network-monitoring appliance to facilitate remotely monitoring a computer network as recited in claim 41, wherein client program interacting with said means for monitoring allows granular monitoring of each respective device attached to said monitored computer network having said client program running thereon.

43. A method of providing remote computer network monitoring, the steps comprising:
a) installing a network-monitoring appliance in a computer network to be monitored thereby creating a monitored computer network, said network-monitoring appliance being adapted to selectively monitor an information packet being transferred on said monitored computer network;
b) redirecting an information packet by said network-monitoring appliance to alter the operation of at least one of: said computer network, a device attached to said computer network, a process running in said network-monitoring appliance, and a process running on a device attached to said computer network.

44. The method of providing remote computer network monitoring as recited in claim 43, wherein said redirecting step (b) redirects said information packet to a different destination for at least one of the reasons: a device is busy, and a device is inoperative.

45. The method of providing remote computer network monitoring as recited in claim 44, wherein said destination is one of the destinations: a server, a printer, a storage device, a network service, and another hardware device.

46. A method of providing network-monitoring services to a customer, the steps comprising:
a) providing a network-monitoring appliance to a customer for installation in a computer network;
b) installing said network-monitoring appliance in said network;
c) establishing communications between said network-monitoring appliance and a monitoring center; and
d) periodically charging a fee to said customer for providing said monitoring service.

47. The method of providing network-monitoring services to a customer as recited in claim 46, wherein said monitoring center is remotely located from said network-monitoring appliance.

48. The method of providing network-monitoring services to a customer as recited in claim 46, wherein said installing step (b) is performed by said customer.

49. The method of providing network-monitoring services to a customer as recited in claim 46, the steps further comprising:
e) periodically upgrading said network-monitoring appliance from said remote monitoring center.

50. The method of providing network-monitoring services to a customer as recited in claim 46, wherein ownership of said network-monitoring appliance is retained by a party other than said customer.

51. The method of providing network-monitoring services to a customer as recited in claim 46, wherein said periodic fee comprises one of the periodic fees: a monthly fee, a quarterly fee, a semi-annual fee, an annual fee, a one-time fee, and a periodic fee in accordance with another fee schedule.

52. The method of providing network-monitoring services to a customer as recited in claim 46, the steps further comprising:
e) replacing said network-monitoring appliance in case of failure thereof.

53. The method of providing network-monitoring services to a customer as recited in claim 46, wherein said replacing step (e) is performed using an overnight delivery service.

54. The method of providing network-monitoring services to a customer as recited in claim 46, wherein said establishing communication step (c) comprises using at least two independent communications channels.

55. The method of providing network-monitoring services to a customer as recited in claim 54, wherein at least one of said at least two independent communications channels comprises a wide area network (WAN).

56. The method of providing network-monitoring services to a customer as recited in claim 55, wherein said WAN comprises the Internet.

57. The method of providing network-monitoring services to a customer as recited in claim 46, the steps further comprising:
e) suspending provision of said network-monitoring services from said remote monitoring center upon non-payment of said periodic fee by said customer.
